(19) United States
(12) Patent Application Publication
(10) Pub. No.: US 2012/0235606 A1
(43) Pub. Date: Sep. 20, 2012

(54) ELECTRIC MOTOR, ROBOT, AND BRAKE DEVICE

(75) Inventor: Kesatoshi TAKEUCHI, Shiojiri (JP)

(73) Assignee: SEIKO EPSON CORPORATION, Tokyo (JP)

(21) Appl. No.: 13/422,175

(22) Filed: Mar. 16, 2012

(30) Foreign Application Priority Data
Mar. 18, 2011 (JP) 2011-060812

(51) Int. Cl. H02P 3/16; H02K 7/102

(52) U.S. Cl. 318/371; 310/77

(57) ABSTRACT

An electric motor includes a rotor and a stator. Apart of the rotor includes a first frictional portion forming a movement locus. The stator includes a second frictional portion which brakes and stops the rotation of the rotor by a mechanical frictional force produced by contact between the second frictional portion and the first frictional portion, and a braking actuator which does not allow application of braking by shifting the second frictional portion away from the first frictional portion during power supply to the electric motor, and allows application of braking by pressing the second frictional portion against the first frictional portion during cutoff of power supply to the electric motor.

### BACKGROUND

1. Technical Field

The present invention relates to an electric motor, and more particularly to braking of an electric motor during cutoff of power supply.

2. Related Art

Under an abnormal condition such as cutoff of power supply, a directly driving type DD motor (electric motor) loses its driving force. When such an abnormal condition occurs in a robot including this type of electric motor, for example, the robot experiences a load drop in some cases. For avoiding this problem, a speed-reduction gear has been used as a device attached to the outside of the electric motor to apply braking thereto. In recent years, such a technology has been proposed which unifies the speed-reduction gear and the electric motor into one body so as to make the electric motor compact as disclosed in JP-A-2007-282377.

According to the structure which combines the speed-reduction gear and the electric motor as one body, however, an additional brake is difficult to be further equipped on the combined unit which has only a limited space for installation of the additional brake.

### SUMMARY

An advantage of some aspects of the invention is to provide an electric motor provided with a brake as one body as a technology capable of solving at least a part of the aforementioned problems.

### APPLICATION EXAMPLE 1

This application example of the invention is directed to an electric motor including a rotor and a stator. Apart of the rotor includes a first frictional portion forming a movement locus. The stator includes a second frictional portion which brakes and stops the rotation of the rotor by a mechanical frictional force produced by contact between the second frictional portion and the first frictional portion, and a braking actuator which does not allow application of braking by shifting the second frictional portion away from the first frictional portion during power supply to the electric motor, and allows application of braking by pressing the second frictional portion against the first frictional portion during cutoff of power supply to the electric motor.

According to this application example, the electric motor and the brake can be unified as one body.

### APPLICATION EXAMPLE 2

This application example of the invention is directed to the electric motor of Application Example 1, wherein the rotor has a hollow cylindrical shape one bottom of which is opened, and includes the first frictional portion disposed on the inner surface of the hollow cylindrical shape of the rotor; and the second frictional portion and the braking actuator are disposed inside or at the opened end of the hollow cylindrical shape of the rotor.

According to this application example, a braking unit including the second frictional portion and the braking actuator is disposed inside or at the opened end of the rotor having the hollow cylindrical shape one bottom of which is opened. Thus, the space necessary for installation of the brake can be easily secured.

### APPLICATION EXAMPLE 3

This application example of the invention is directed to the electric motor of Application Example 2, wherein the first frictional portion is disposed inside the cylindrical side surface of the hollow cylindrical shape; and the braking actuator presses the second frictional portion against the first frictional portion in a radial direction.

According to this application example, the braking actuator and the second frictional portion can be disposed inside the rotor.

### APPLICATION EXAMPLE 4

This application example of the invention is directed to the electric motor of Application Example 2, wherein the first frictional portion is disposed on the bottom of the hollow cylindrical shape on the side not opened.

According to this application example, the second frictional portion can be disposed inside the rotor.

### APPLICATION EXAMPLE 5

This application example of the invention is directed to the electric motor of Application Example 3 or 4, wherein the first frictional portion has a convex or concave shape with respect to the second frictional portion; and the second frictional portion has a concave or convex shape with respect to the first frictional portion as the opposite shape of the first frictional portion.

According to this application example, the contact area between the first frictional portion and the second frictional portion increases. Thus, the sizes of the first and second frictional portions can be reduced.

### APPLICATION EXAMPLE 6

This application example of the invention is directed to the electric motor of any of Application Examples 1 to 5, which further includes a braking controller which controls the operation of the braking actuator, and an electromagnetic coil provided on the stator. The braking controller has a delay circuit which allows the braking actuator to apply braking after an elapse of a predetermined time from cutoff of power supply to the electric motor. During power supply to the electric motor, the braking controller rotates the rotor without allowing the braking actuator to apply braking. During cutoff of power supply to the electric motor, the braking controller draws regenerative current produced by induced voltage generated by the electric motor to allow application of braking of the rotor by utilizing the regenerative current as regenerative braking, in which case the braking controller allows the braking actuator to apply braking after the elapse of the predetermined time.

According to this application example, braking is applied after decrease in the number of rotations by application of a so-called rheostatic brake. Thus, the components required for braking can be small-sized.

### APPLICATION EXAMPLE 7

This application example of the invention is directed to an electric motor including a rotor, a stator, a braking unit which brakes the rotation of the rotor, a braking actuator which operates the braking unit, and a braking controller which controls the operation of the braking actuator. The braking controller has a delay circuit which allows the braking actuator to apply braking after an elapse of a predetermined time from cutoff of power supply to the electric motor. During power supply to the electric motor, the braking controller rotates the rotor without allowing the braking actuator to apply braking. During cutoff of power supply to the electric motor, the braking controller draws regenerative current produced by induced voltage generated by the electric motor to allow application of braking by utilizing the regenerative current as regenerative braking, in which case the braking controller allows the braking actuator to apply braking after the elapse of the predetermined time.

### APPLICATION EXAMPLE 8

This application example of the invention is directed to an electric motor including a rotor, a stator, a braking unit which brakes the rotation of the rotor, a braking actuator which operates the braking unit, and a braking controller which controls the operation of the braking actuator. The braking controller has a delay circuit which allows the braking actuator to apply braking after an elapse of a predetermined time from cutoff of power supply to the electric motor. During power supply to the electric motor, the braking controller rotates the rotor without allowing the braking actuator to apply braking. During cutoff of power supply to the electric motor, the braking controller rotates the rotor without allowing the braking actuator to apply braking and draws regenerative current produced by induced voltage generated by the electric motor to allow application of braking by utilizing the regenerative current as regenerative braking when detecting a large number of rotations of the electric motor based on the induced voltage corresponding to the large number of rotations of the electric motor, and allows the braking actuator to apply braking when detecting a small number of rotations of the electric motor based on the induced voltage corresponding to the small number of rotations of the electric motor.

According to this application example, the braking controller applies braking after the number of rotations of the electric motor decreases by application of the regenerative braking produced by the induced voltage corresponding to the number of rotations of the electric motor during cutoff of power supply. Accordingly, the components required for braking can be small-sized.

### APPLICATION EXAMPLE 9

This application example of the invention is directed to a robot including the electric motor of any of Application Examples 1 to 8.

The electric motor according to the application example of the invention can be used in various forms, such as a braking device, a robot, and a braking method for an electric motor.

### BRIEF DESCRIPTION OF THE DRAWINGS

The invention will be described with reference to the accompanying drawings, wherein like numbers reference like elements.

FIG. 1 is a cross-sectional view illustrating the general internal structure of a robot arm 10.

FIG. 2 schematically illustrates deformation of the robot arm 10.

FIG. 3 is a cross-sectional view illustrating the general internal structure of a driving power generator 100.

FIG. 4 illustrates the shapes of a brake pad 2110 and a first frictional portion 2121 according to an example.

FIG. 5 illustrates the shapes of the brake pad 2110 and the first frictional portion 2121 according to another example.

FIG. 6 illustrates the shapes of the brake pad 2110 and the first frictional portion 2121 according to a further example.

FIG. 7 illustrates the structure of an actuator.

FIG. 8 schematically illustrates the general structure of a driving power generator 100C according to a second embodiment of the invention.

FIG. 9 schematically illustrates a brake according to the second embodiment.

FIG. 10 schematically illustrates the general structure of a driving power generator 100E according to a third embodiment of the invention.

FIG. 11 schematically illustrates a cyclo-mechanism.

FIG. 12 schematically illustrates a brake according to the third embodiment.

FIG. 13 schematically illustrates the structure of a motor unit 120 according to an example of the respective embodiments.

FIG. 14 illustrates the structure of a braking controller 1150.

FIG. 15 shows voltages generated in an electromagnetic coil.

FIGS. 16A and 16B schematically illustrate the structure of the motor unit 120 according to another example.

FIG. 17 schematically illustrates the structure of a braking controller according to a further example.

FIG. 18 schematically illustrates the structure of a braking controller according to a still further example.

### DESCRIPTION OF EXEMPLARY EMBODIMENTS

### A. First Embodiment

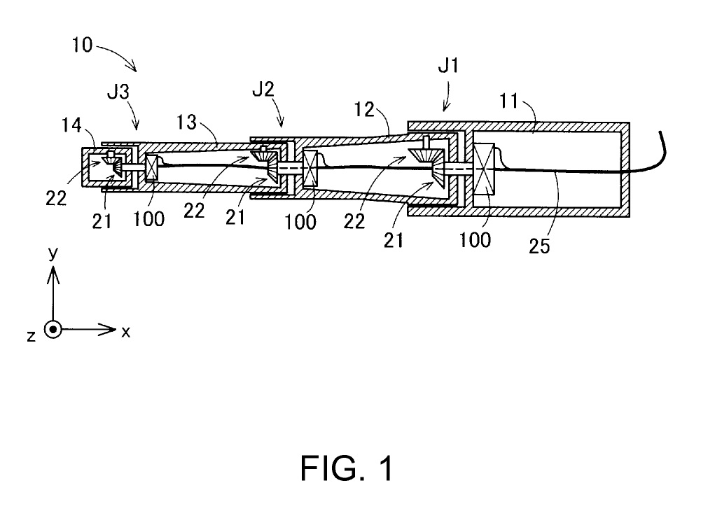

FIG. 1 is a cross-sectional view illustrating the general internal structure of a robot arm 10. The robot arm 10 includes four base bodies 11 through 14. The four base bodies 11 through 14 are connected with each other in series in the x direction via first through third joints J1 through J3. FIG. 1 shows three-dimensional arrows x, y and z crossing each other at right angles. Hereinafter, the first base body 11 side of the robot 10 is referred to as the “rear end side”, while the fourth base body 14 side is referred to as the “front end side”.

The respective base bodies 11 through 14 are hollow components containing driving power generators 100 as driving power sources for the respective joints J1 through J3, two types of bevel gears 21 and 22 to which the driving forces of the driving power generators 100 are transmitted. The structure of the first joint J1 which connects the first and second base bodies 11 and 12 is now explained. Each of the structures of the second joint J2 connecting the second and third base bodies 12 and 13 and the third joint J3 connecting the third and fourth base bodies 13 and 14 is similar to the structure of the first joint J1, and is not specifically explained herein.

The first joint J1 includes the driving power generator 100 and the bevel gears 21 and 22. The driving power generator 100 has a motor which produces a rotational driving force by using an electromagnetic force. The details of the internal structure of the driving power generator 100 will be described later. The driving power generator 100 is disposed on the front end side of the first base body 11, and connected with a rotation shaft of the first bevel gear 21. The first bevel gear 21 is arranged such that its rotation shaft penetrates the boundary between the first and second base bodies 11 and 12. A gear provided at the tip of the rotation shaft of the first bevel gear 21 is positioned within the second base body 12.

The second bevel gear 22 is fixedly attached to the inner wall surface of the second base body 12 on the rear end side thereof in such a condition that the gear of the second bevel gear 22 is joined with the gear of the first bevel gear 21. The rotational driving force transmitted from the driving power generator 100 rotates the first bevel gear 21. This rotation of the first bevel gear 21 rotates the second bevel gear 22, along therewith the second base body 12 rotates.

Conductive lines 25 as a plurality of conductive lines which carry power and control signals toward the respective driving power generators 100 are inserted through the interior of the robot arm 10. More specifically, the conductive lines 25 are inserted into the first base body 11 from the rear end thereof. A part of the inserted conductive lines 25 branches to connect with a connection section of the driving power generator 100 disposed inside the first base body 11. The remaining part of the conductive lines 25 passes through a through hole (described later) provided at the center of the driving power generator 100, and a through hole (not shown) penetrating the center shaft of the first bevel gear 21 to reach the second base body 12.

The conductive lines 25 are wired in a similar manner in the second base body 12. More specifically, a part of the conductive lines 25 inserted into the second base body 12 connects with the driving power generator 100, while the remaining part passes through the interiors of the driving power generator 100 and the first bevel gear 21 to reach the third base body 13. The conductive lines 25 inserted into the third base body 13 are connected with the driving power generator 100.

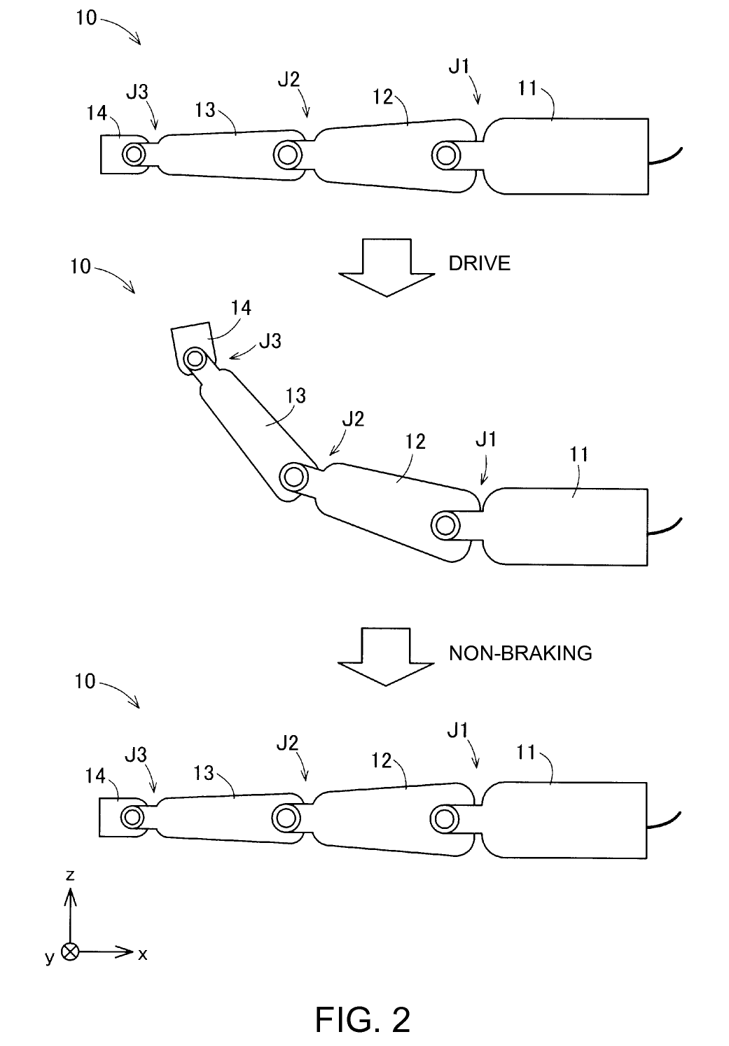

FIG. 2 schematically illustrates deformation of the robot arm 10. FIG. 2 depicts three conditions of the robot arm 10: a condition prior to deformation; a condition during deformation; and a condition of the original shape returned after deformation by cutoff of power supply during deformation without application of braking. FIG. 2, which uses three-dimensional arrows x, y, and z similar to those of FIG. 1 for illustration, shows the robot arm 10 rotated through 90 degrees around the x axis from the position in FIG. 1. During driving, the robot arm 10 changes its shape into a curved shape on the whole, for example, by the change of the connection angles between the respective base bodies 11 through 14 in accordance with the rotations of the respective joints J1 through J3. The condition shown in middle part of FIG. 2 corresponds to that of the robot arm 10 curved upward as viewed in the figure as an example of the deformation of the robot arm 10. When the power supply to the driving power generator 100 is cut off under this condition, the curved robot arm 10 provided with no braking mechanism returns to its original shape by the weights of the base bodies 12 through 14.

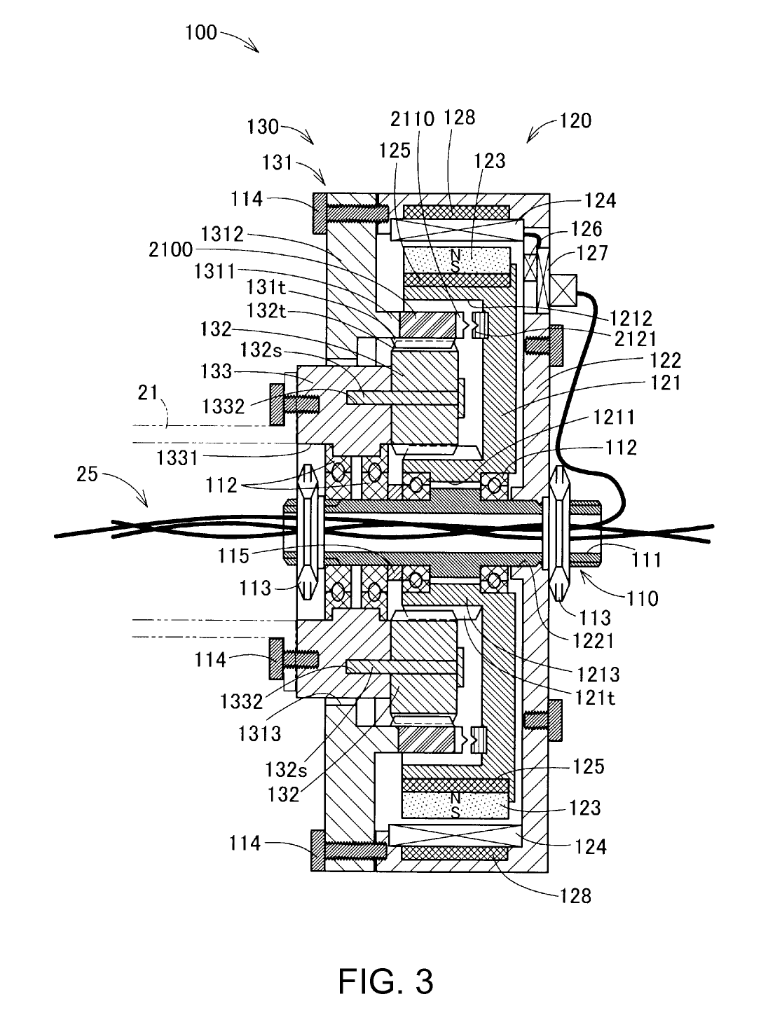

FIG. 3 is a cross-sectional view illustrating the general internal structure of the driving power generator 100. FIG. 3 shows the rotation shaft of the first bevel gear 21 connected with the driving power generator 100 by broken lines. The driving power generator 100 includes a center shaft 110, a motor unit 120, and a rotating mechanism 130.

The motor unit 120 and the rotating mechanism 130 engage with each other as one body (details of which will be described later). The center shaft 110 is provided in such a position as to penetrate the centers of the motor unit 120 and the rotating mechanism 130 combined as one body. The center shaft 110 has a through hole 111 extending in the axial direction, through which hole 111 the conductive lines 25 are inserted.

The motor unit 120 has a rotor 121 and a casing 122. The motor unit 120 has a radial gap type structure constructed as follows. The rotor 121 has a cylindrical shape one bottom of which is opened. A cylindrical permanent magnet 123 is disposed on the outer circumference of the side surface of the cylindrical shape of the rotor 121. The magnetic flux of the permanent magnet 123 extends in the radial direction. A magnet back yoke 125 is disposed on the rear surface of the permanent magnet 123 (surface near the side wall of the rotor 121) to increase the magnetic force efficiency.

A through hole 1211 through which the center shaft 110 is inserted is provided at the center of the rotor 121. Bearings 112 are provided between the inner wall surface of the through hole 1211 and the outer circumferential surface of the center shaft 110 to allow rotation of the rotor 121 around the center shaft 110. The bearings 112 may be of a ball bearing structure type, for example.

A recess 1212 as a substantially annular groove around the through hole 1211 is formed in the surface of the rotor 121 opposed to the rotating mechanism 130. Gear teeth 121t are provided on the outer wall surface of a substantially cylindrical partition 1213 which separates the through hole 1211 from the recess 1212. The partition 1213 disposed at the center of the rotor 121 and provided with the gear teeth 121t is hereinafter referred to as a “rotor gear 1213”. The rotor gear 1213 in this embodiment functions as a sun gear for planet gears, the details of which will be described later.

The casing 122 is a substantially cylindrical hollow container whose surface opposed to the rotating mechanism 130 is opened to accommodate the rotor 121. The casing 122 may be made of resin material such as carbon fiber reinforced plastics (CFRP). The casing 122 made of this material contributes to reduction of the weight of the driving power generator 100.

A through hole 1221 formed at the center of the bottom of the casing 122 is a hole through which the center shaft 110 is inserted. The center shaft 110 and the casing 122 are fixedly attached to each other. A bearing ring 113 is attached to the outside of the casing 122 by engagement therewith so that the center shaft 110 can be securely held by the casing 122.

An electromagnetic coil 124 is arranged in a cylindrical shape on the inner circumferential surface of the casing 122 at a position opposed to the permanent magnet 123 of the rotor 121 with a clearance between the electromagnetic coil 124 and the permanent magnet 123. According to this structure, the electromagnetic coil 124 functions as a stator in the motor unit 120 for rotating the rotor 121 around the center shaft 110. A coil back yoke 128 is provided between the electromagnetic coil 124 and the casing 122 so as to increase the magnetic force efficiency.

A position detector 126 which detects the position of the permanent magnet 123, and a rotation control circuit 127 which controls the rotation of the rotor 121 are provided on the bottom of the casing 122. The position detector 126 is constituted by a hall device, for example, and disposed in such a position as to correspond to the position of the permanent circular orbit. The position detector 126 is connected with the rotation control circuit 127 via a signal line.

The rotation control circuit 127 connects with the conductive line branched from the conductive lines 25. The rotation control circuit 127 also electrically connects with the electromagnetic coil 124. The rotation control circuit 127 transmits a detection signal received from the position detector 126 to a controller (not shown) which controls the driving of the driving power generator 100. The rotation control circuit 127 also supplies power to the electromagnetic coil 124 to allow generation of a magnetic field therefrom and rotation of the rotor 121 thereby in accordance with a control signal received from the controller.

The rotating mechanism 130 constituting planet gears together with the rotor gear 1213 of the rotor 121 functions as a speed-reduction gear. The rotating mechanism 130 includes a gear fixing portion 131, three planetary gears 132, and a load connection portion 133. FIG. 3 shows only the two planetary gears 132 for convenience of explanation.

The gear fixing portion 131 has an outer gear 1311 as a substantially annular gear which has gear teeth 131t on the inner wall surface thereof, and a flange 1312 projecting from the outer circumference of the outer gear 1311. The gear fixing portion 131 is fixedly attached to the motor unit 120 by junction between the flange 1312 and the side wall end surface of the casing 122 of the motor unit 120 via fixing bolts 114.

The outer gear 1311 of the gear fixing portion 131 is accommodated within the recess 1212 of the rotor 121. The three planetary gears 132 are disposed between the inner circumferential surface of the outer gear 1311 and the outer circumferential surface of the rotor gear 1213 substantially at equal intervals on the outer circumference of the rotor gear 1213. The three types of the gears 1213, 132, and 1311 are connected with each other by engagement between gear teeth 132t of the planetary gears 132, the gear teeth 131t of the outer gear 1311, and the gear teeth 121t of the rotor gear 1213.

The load connection portion 133 is a substantially cylindrical component functioning as a planetary carrier. A through hole 1331 through which the center shaft 110 is inserted is formed at the center of the bottom of the load connection portion 133. The bearings 112 are disposed between the inner wall surface of the through hole 1331 and the outer circumferential surface of the center shaft 110 to allow rotation of the load connection portion 133 around the center shaft 110. A spacer 115 is provided between the bearings 112 attached to the load connection portion 133 and the bearings 112 attached to the rotor 121.

A substantially circular opening 1313 communicating with the space inside the inner circumference of the outer gear 1311 is formed at the center of the gear fixing portion 131. The load connection portion 133 is disposed within the opening 1313. Shaft holes 1332 are formed in the bottom of the load connection portion 133 near the motor unit 120 (right side in FIG. 3) such that rotation shafts 132s of the planetary gears 132 accommodated within the recess 1212 of the rotor 121 can be rotatably supported on the shaft holes 1332.

The bearing ring 113 is further attached to the outside bottom of the load connection portion 133 (left side in FIG. 3) by engagement therewith such that the center shaft 110 can be securely supported. The rotation shaft of the first bevel gear 21 is fixed to the outside bottom of the load connection portion 133 via the fixing bolts 114.

According to the first embodiment, the driving power generator 100 is equipped with a brake. The brake includes a first frictional portion 2121, a braking actuator 2100, and a brake pad 2110. The positions of the components 2121, 2100, and 2110 are determined as follows. The rotor 121 has a hollow cylindrical shape whose one surface is opened as explained above, and the first frictional portion 2121 is disposed on the inner surface of the bottom of the rotor 121 on the side not opened. The stator has the casing 122 and the gear fixing portion 131 as noted above. The flange 1312 of the gear fixing portion 131 is inserted into the cylindrical shape of the rotor 121. The braking actuator 2100 and the brake pad 2110 are disposed at the leading edge of the flange 1312. Thus, the braking actuator 2100 and the brake pad 2110 are contained within the cylindrical shape of the rotor 121.

During braking, the brake pad 2110 is pressed against the first frictional portion 2121 of the rotor 121 by the operation of the braking actuator 2100 so that the rotation of the rotor 121 can be reduced by the frictional force generated between the brake pad 2110 and the first frictional portion 2121. The first frictional portion 2121 and the rotor 121 may be made of either the same material, or different materials. When the first frictional portion 2121 and the rotor 121 are made of the same material, the first frictional portion 2121 is not required to be clearly sectioned from the other part of the rotor 121. In this case, the area of the rotor 121 brought into contact with the brake pad 2110 functions as the first frictional portion 2121. There may be equipped n number of the braking actuators 2100 and n number of the brake pads 2110 (n: two or larger integer). When n number of the braking actuators 2100 and n number of the braking pads 2110 are provided, it is preferable that these components 2100 and 2110 are disposed with n-fold symmetry around the center shaft 110.

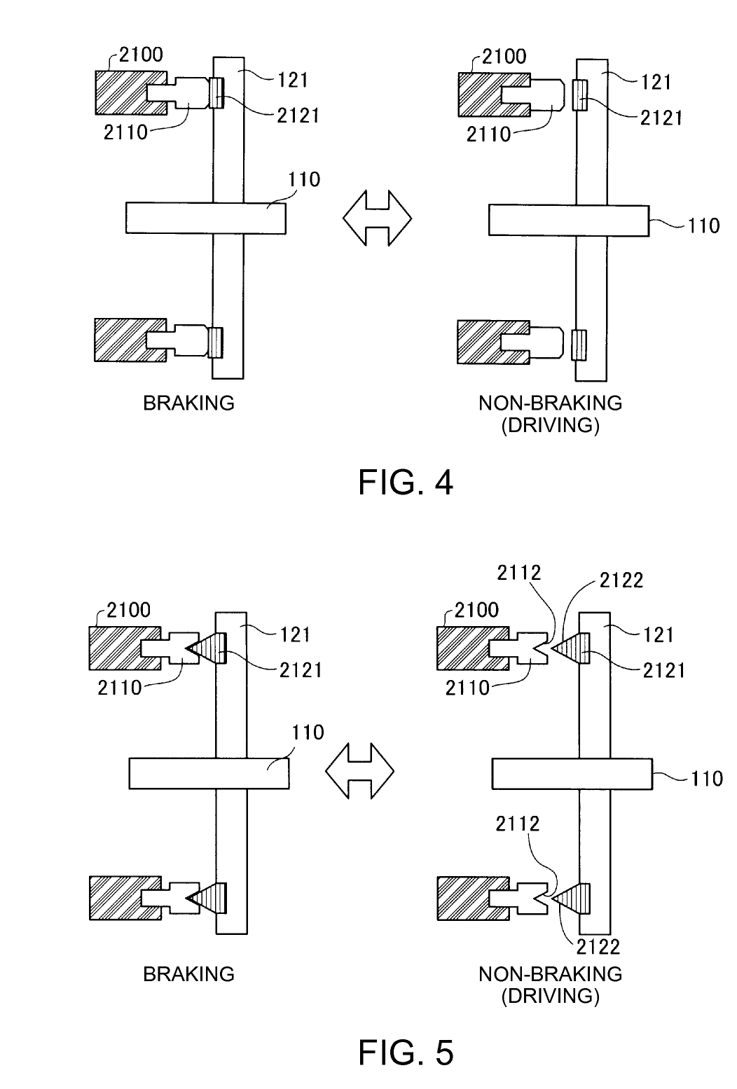

FIGS. 4 through 6 illustrate variations in the shapes of the brake pad 2110 and the first frictional portion 2121. Various forms may be adopted as the shapes of the brake pad 2110 and the first frictional portion 2121. According to an example shown in FIG. 4, the shape of the brake pad 2110 on the side facing to the rotor 121, and the shape of the first frictional force 2121 are both flat. In this example, the flat shapes of the brake pad 2110 and the first frictional portion 2121 widen the contact area between the brake pad 2110 and the first frictional portion 2121. Thus, the braking force increases.

According to an example shown in FIG. 5, the first frictional portion 2121 has a circular convex portion 2122 on the side facing to the brake pad 2110, while the brake pad 2110 has a concave 2112 on the side facing to the first frictional portion 2121. The convex 2122 provided on the first frictional portion 2121 and the concave 2112 on the brake pad 2110 further widen the contact area between the brake pad 2110 and the first frictional portion 2121, thereby further raising the braking force. It is possible to provide a circular concave portion on the first frictional portion 2121 on the side facing to the brake pad 2110, in which case a convex portion is formed on the brake pad 2110 on the side facing to the first frictional portion 2121.

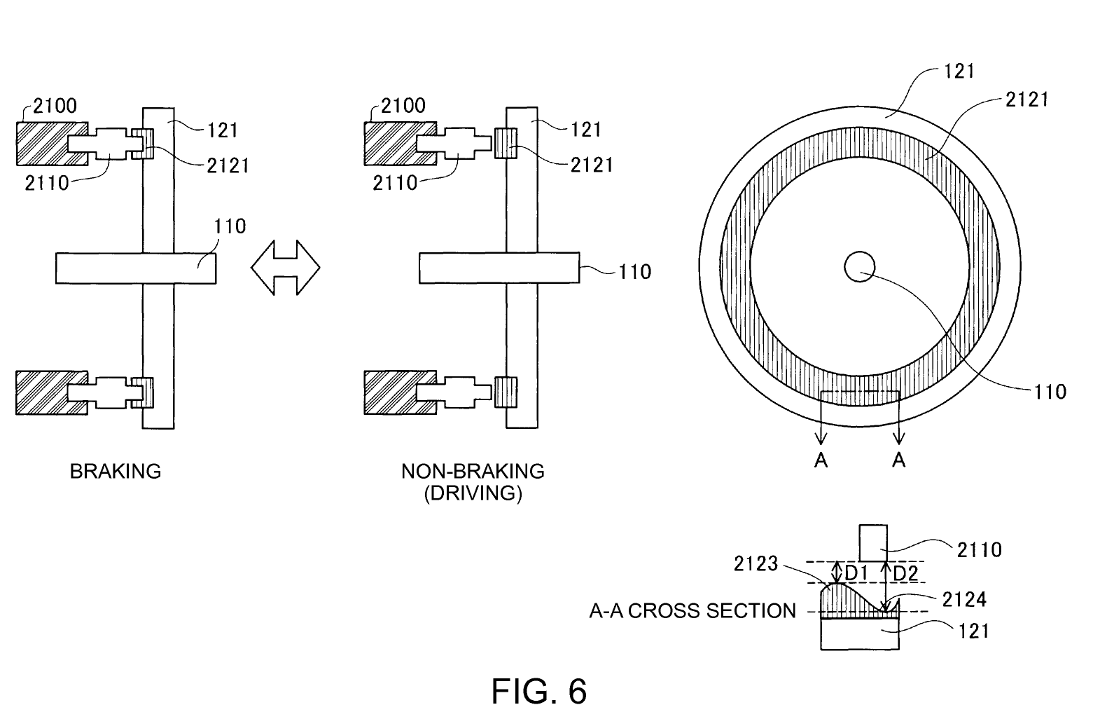

According to an example shown in FIG. 6, the shape of the brake pad 2110 on the side facing to the rotor 121 is flat, while the shape of the first frictional portion 2121 is waved such that a portion 2123 having a short distance D1 between the brake pad 2110 and the first frictional portion 2121 and a portion 2124 having a long distance D2 between the brake pad 2110 and the first frictional portion 2121 are formed. It is preferable that each number of the portions 2123 having the short distance D1 and the portions 2124 having the long distance D2 are equivalent to each number of the braking actuators 2100 and the brake pads 2110. It is further preferable that the portions 2123 having the short distance D1 are disposed with n-fold symmetry with respect to the center shaft 110. This also applies to the portions 2124 having the long distance D2. According to this structure, when the brake pad 2110 is pressed against the portion 2124 having the long distance D2 on the first frictional portion 2121, the rotor 121 is required to push back the brake pad 2110 toward the side opposite to the rotor 121 so as to rotate along with contact between the brake pad 2110 and the portion 2123 having the short distance D1 on the rotor 121. In this case, a pushing back force is also generated as well as the frictional force between the brake pad 2110 and the rotor 121. Accordingly, this structure sufficiently decreases the rotation of the rotor 121 with an improved braking force.

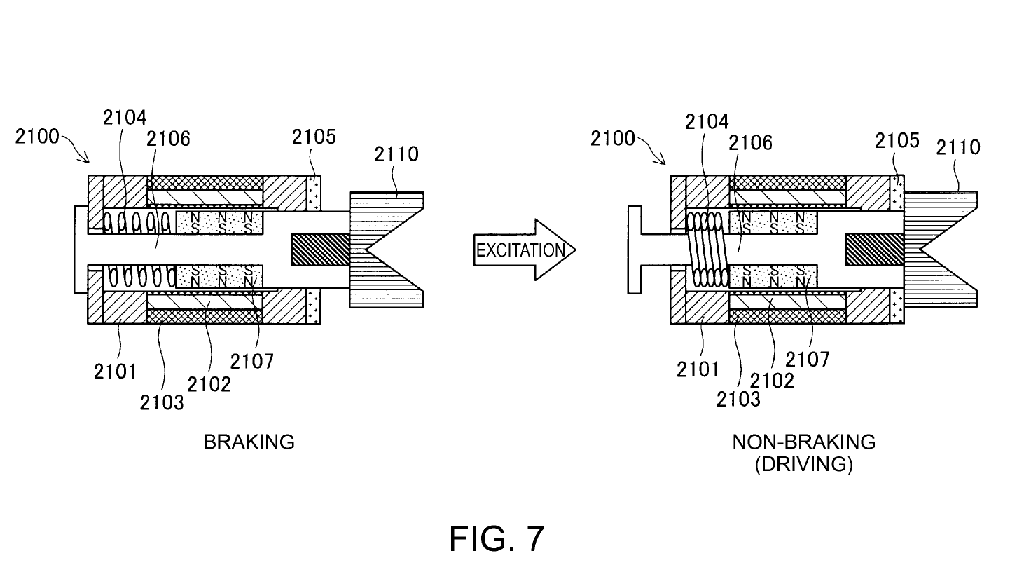

FIG. 7 illustrates the structure of the actuator. While FIG. 7 shows the brake pad 2110 having the shape shown in the example in FIG. 5, any of the shapes of the brake pad 2110 and the first frictional portion 2121 shown in FIGS. 4 through 6 may be adopted for the structure illustrated in FIG. 7. The braking actuator 2100 includes a fixed portion 2101 and a movable portion 2106. The fixed portion 2101 has a coil 2102, a coil back yoke 2103, a spring 2104, and a cushioning portion 2105. The movable portion 2106 has the brake pad 2110 at the end thereof on the side facing to the first frictional portion 2121, and a magnet 2107 which has the N pole and the S pole on the outer circumference and the inner circumference, respectively, of the magnet 2107, at the end of the movable portion 2106 on the side opposite to the end where the brake pad 2110 is provided.

The fixing portion 2101 has a hollow cylindrical shape, and accommodates the spring 2104 and the movable portion 2106 within the hollow space of the fixing portion 2101. The spring 2104 is disposed in the vicinity of the end of the movable portion 2106 on the side opposite to the brake pad 2110. The fixed portion 2101 has the coil 2102 on the inner wall thereof facing to the hollow space. The coil 2102 is wound in the shape of a solenoid, and functions as an electromagnet when current flows therein. The coil back yoke 2103 is provided on the outer wall of the coil 2102. The coil back yoke 2103 prevents leakage of the magnetic flux of the coil 2102 to the outside of the braking actuator 2100 when the coil 2102 functions as an electromagnet. The cushioning portion 2105 is disposed at the end of the fixed portion 2101 on the side facing to the brake pad 2110. The brake pad 2110 is larger than the hollow space of the fixed portion 2101 such that the brake pad 2110 and the fixed portion 2101 collide with each other when the movable portion 2106 and the brake pad 2110 shift toward the spring 2104. The cushioning portion 2105 absorbs the shock of collision between the brake pad 2110 and the fixed portion 2101. The movable portion 2106 has the magnet 2107 at the end thereof opposite to the end to which the brake pad 2110 is attached.

The operation of the actuator is now explained. According to this embodiment, current flows in the coil 2102 during current supply to the driving power generator 100, and current supply to the coil 2102 stops during cutoff of current supply to the driving power generator 100. While current is flowing in the coil 2102, the coil 2102 functions as an electromagnet and shifts the magnet 2107 toward the spring 2104. As a result, the brake pad 2110 moves away from the rotor 121 (FIG. 3). On the other hand, when current supply to the driving power generator 100 is cut off, current supply to the coil 2102 stops accordingly. In this case, the coil 2102 does not function as an electromagnet, and the spring 2104 pushes the movable portion 2106 toward the right in the figure. Consequently, the brake pad 2110 pushed toward the right in the figure along with the movement of the movable portion 2106 contacts the rotor 121 (FIG. 3) and brakes the rotor 121 to a stop. There is a correlation between the amount of the exciting current flowing in the coil 2102 and the braking torque. That is, the spring force of the spring 2104 starts acting in accordance with gradual decrease in the amount of the exciting current, as transition in the braking torque control from the small braking torque to the large braking torque. When only on/off of the braking is needed, a soft magnetic material may be employed as a solenoid in place of the magnet 2107. While the magnet 2107 has the N pole and the S pole on its outer circumference and its inner circumference, respectively, according to this embodiment, the N pole and the S pole of the magnet 2107 may be disposed on the inner circumference and the outer circumference, respectively. In this case, the direction of the current flowing in the coil 2102 is reversed.

According to the first embodiment, the brake functions as a mechanism for maintaining the condition of the robot arm 10 curved upward as illustrated in the middle of FIG. 2, when current supply to the driving power generator 100 is cut off under the condition shown in the middle of the figure. In this embodiment, in addition, the braking actuator 2100 and the brake pad 2110 are accommodated inside the rotor 121. Thus, the space necessary for installation of the brake can be easily secured.

### B. Second Embodiment

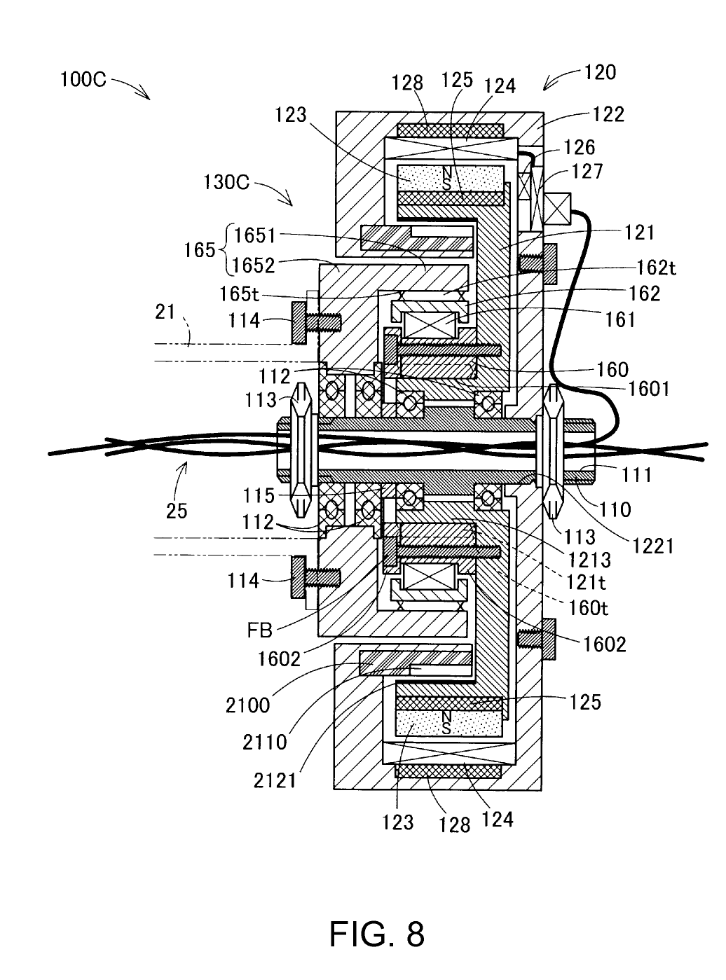

FIG. 8 illustrates the general structure of a driving power generator 100C according to a second embodiment of the invention. While the driving power generator 100 in the first embodiment has the planet gears as the rotating mechanism, the driving power generator 100C in the second embodiment has a harmonic drive mechanism (“harmonic drive” is a registered trademark) and a motor combined as one body which functions as the rotating mechanism for transmitting the rotational driving force to the bevel gear 21. The driving force generator 100C is different from the driving force generator 100 (FIG. 3) in the first embodiment in the following points.

The driving power generator 100C has a rotating mechanism 130C provided with a wave generator 160, a flex spline 162, and a circular spline 165 as components of the harmonic drive mechanism, all components 160, 162, and 165 of which are accommodated within the recess 1212 of the rotor 121. The wave generator 160 has a substantially ellipse pole shape which has a substantially elliptical bottom surface.

The wave generator 160 has a through hole 1601 penetrating the wave generator 160 in the center axis direction (left-right direction in the figure), and gear teeth 160t on the inner wall surface of the through hole 1601. The wave generator 160 is fastened to the rotor 121 via fastening bolts FB with the rotor gear 1213 accommodated in the through hole 1601 by engagement. In this arrangement, the wave generator 160 rotates in accordance with the rotation of the rotor 121.

A flange 1602 projecting in the direction toward the outer circumferential side is disposed at each of both ends of the wave generator 160. These flanges 1602 are provided to prevent separation of the flex spline 162 from the outer circumference of the wave generator 160.

The flex spline 162 is an annular flexible component deformable in accordance with the rotation of the wave generator 160, and has gear teeth 162t on the outer circumferential surface of the flex spline 162. A bearing 161 is provided on the inner circumferential surface of the flex spline 162 for smooth rotation of the wave generator 160.

The circular spline 165 accommodated in the recess 1212 of the rotor 121 has a front part 1651 which accommodates the flex spline 162 inside, and a rear part 1652 through which the center shaft 110 is inserted and to which the rotation shaft of the bevel gear 21 is connected. Gear teeth 165t engaging with the gear teeth 162t of the flex spline 162 are disposed on the inner circumferential surface of the front part 1651. On the other hand, the bearings 112 are disposed between the rear part 1652 and the center shaft 110 to allow rotation of the circular spline 165.

The brake according to the second embodiment includes the first frictional portion 2121, the braking actuator 2100, and the brake pad 2110. These components 2121, 2100, and 2110 have the following structures. As explained above, the rotor 121 has a hollow cylindrical shape one surface of which is opened. The first frictional portion 2121 is disposed on the inner surface of the cylindrical shape of the rotor 121. As discussed above, the stator has the casing 122 and the circular spline 165. The front part 1651 of the circular spline 165 is inserted into the cylindrical shape of the rotor 121. The front part 1651 has a substantially cylindrical shape. The braking actuator 2100 and the brake pad 2110 are disposed near the outer periphery of the front part 1651.

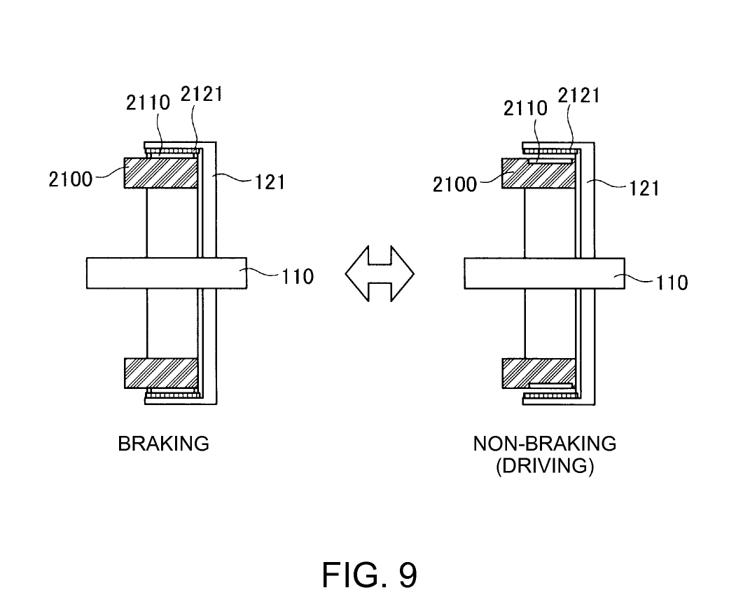

FIG. 9 schematically illustrates the brake according to the second embodiment. The brake in this embodiment is similar to the brake in the first embodiment in that the braking actuator 2100 and the brake pad 2110 are contained within the hollow cylindrical rotor 121. However, while the brake pad 2110 is opposed to the bottom of the rotor 121 in the first embodiment, the brake pad 2110 in the second embodiment is opposed to the cylindrical side surface of the rotor 121. In addition, while the shift direction of the brake pad 2110 during braking is parallel with the center shaft 110 in the first embodiment, this shift direction in the second embodiment radially extends around the center shaft 110. It is preferable that n number (n: two or larger integer) of the braking actuators 2100 and n number of the brake pads 2110 are equipped. In this case, it is preferable that these braking actuators 2100 and brake pads 2110 are disposed with n-fold symmetry around the center shaft 110.

Similarly to the first embodiment, the braking actuator 2100 and the brake pad 2110 in the second embodiment are accommodated within the hollow cylindrical rotor 121. Thus, the space necessary for installation of the brake can be easily secured. Moreover, according to the second embodiment, the sum of the vectors of the forces applied to the rotor 121 from the respective brake pads 2110 becomes zero. In this case, the rotor 121 does not move by the forces received from the respective brake pads 2110, which increases the stability of braking.

The brake pad 2110 and the first frictional portion 2121 in the second embodiment may have various shapes similar to those shown in FIGS. 4 through 6 in the first embodiment.

### C. Third Embodiment

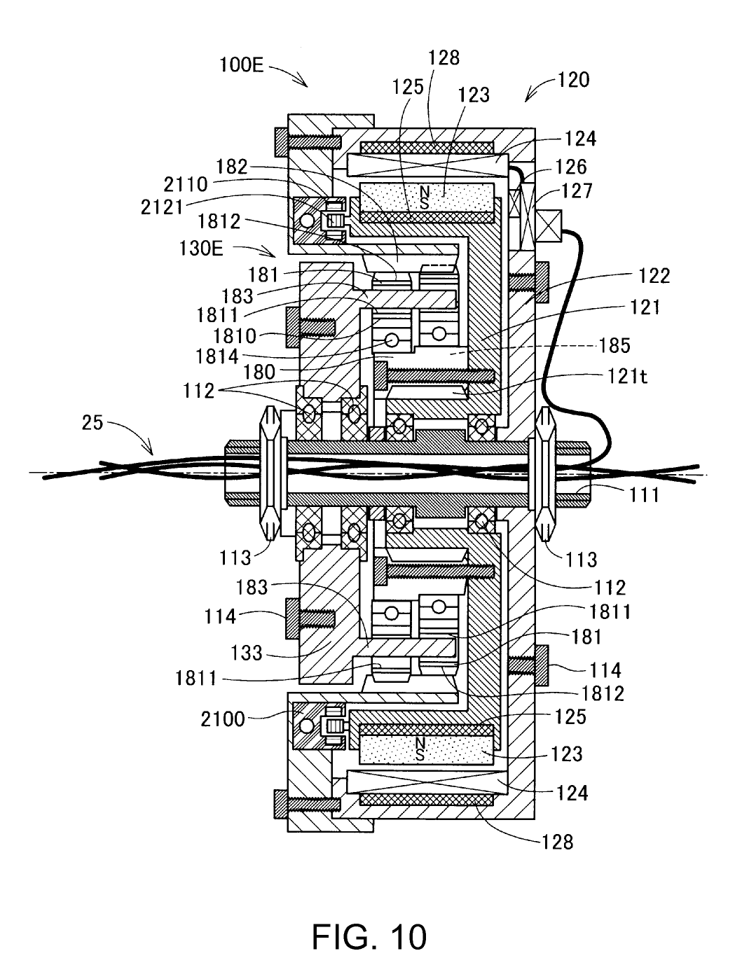

FIG. 10 illustrates the general structure of a driving power generator 100E according to a third embodiment of the invention. The driving power generator 100E in this embodiment has a cyclo-mechanism and a motor combined into one body, and transmits a rotational driving force to the load connection portion 133. The driving power generator 100E is different from the driving power generator 100 (FIG. 3) in the first embodiment in the point that a cyclo-mechanism is provided as a rotating mechanism 130E in the recess 1212 of the rotor 121.

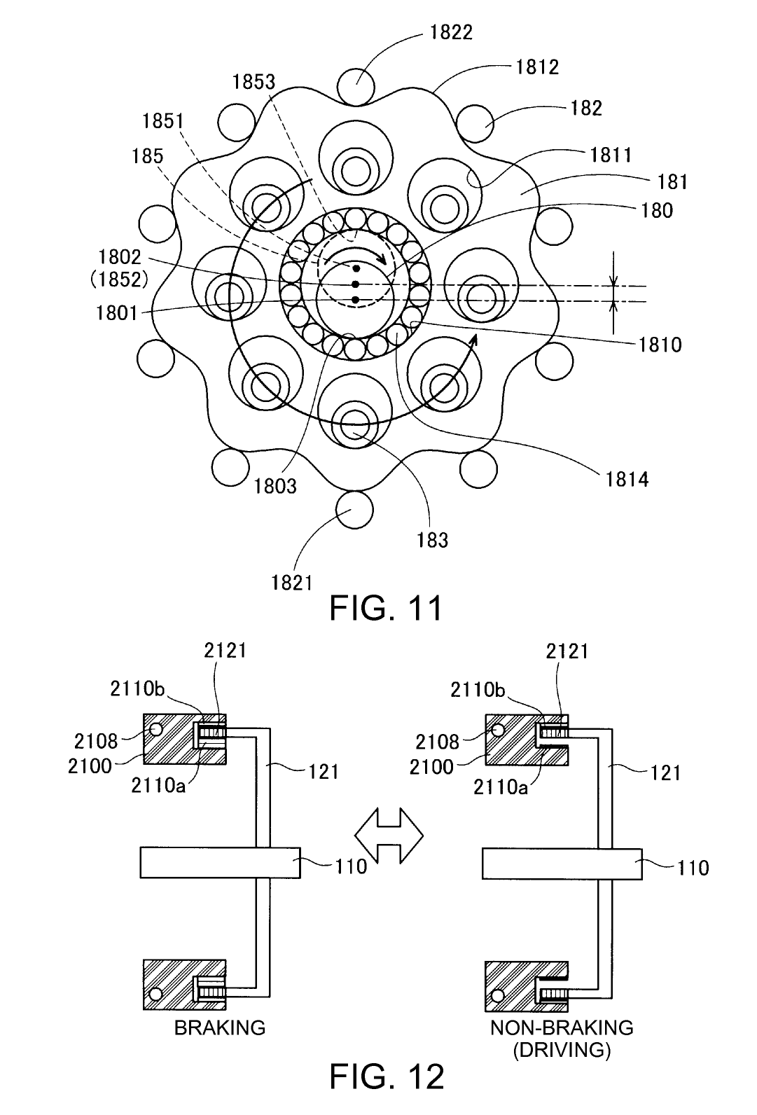

FIG. 11 schematically illustrates the cyclo-mechanism. The cyclo-mechanism includes eccentric bodies 180 and 185, a curved plate 181, outside pins 182, inside pins 183, and a bearing 1814. The curved plate 181 has a substantially disk shape, and includes a center hole 1810 at the center thereof. The curved plate 181 further has eight inside pin holes 1811 around the center hole 1810. The inside pin holes 1811 are disposed on a circumference at intervals of 45 degrees. The outer circumference of the curved plate 181 has an epitrochoid parallel curve shape. According to this embodiment, the number of peaks of the epitrochoid parallel curve shape is nine, and the epitrochoid parallel curve shape overlaps with the shape prior to rotation when rotated through 40 degrees. According to this embodiment, the cyclo-mechanism has the two curved plates 181 shifted from each other at 180 degrees as illustrated in FIG. 10. In this arrangement, the protrusions of the epitrochoid parallel curved shape of the one curved plate 181 are located at the concaves of the epitrochoid parallel curved shape of the other curved plate 181. FIG. 11 shows only one of the curved plates 181 for easy understanding of the figure.

The outside pins 182 are components each of which has a substantially circular shape on the side facing to the curved plate 181. The outside pins 182 may be constituted by cylindrical bars. According to this embodiment, there are provided the ten outside pins 182 positioned on a circumference at intervals of 36 degrees. The outside pins 182 are disposed in such positions as to contact the outer circumference of the curved plate 181. When an outside pin 1821 of the outside pins 182 contacts one of the peaks of the projections of the epitrochoid parallel curved shape of the curved plate 181, an outside pin 1822 located at a symmetric position of the outside pin 1821 contacts the bottom of the corresponding concave of the epitrochoid parallel curved shape of the curved plate 181. FIGS. 10 and 11 illustrate the outside pins 182 and the curved plate 181 contacting each other in the manner of concaved and convexed gear teeth.

The inside pins 183 are constituted by cylindrical bars. According to this embodiment, the same number (eight) of the inside pins 183 as the number of the inside pin holes 1811 are provided and disposed along a circumference at intervals of 45 degrees. Each thickness of the inside pins 183 is smaller than each thickness of the inside pinholes 1811 so that the inside pins 183 can be inserted into the corresponding inside pin holes 1811. The size of the circumference on which the inside pins 183 are disposed is equalized with the size of the circumference on which the inside pin holes 1811 are disposed.

Each of the eccentric bodies 180 and 185 has a cylindrical shape. A center 1801 of the eccentric body 180 is shifted from a rotation center 1802 of the eccentric body 180. A center 1851 of the eccentric body 185 is shifted from a rotation center 1852 of the eccentric body 185. The rotation center 1802 of the eccentric body 180 and the rotation center 1852 of the eccentric body 185 agree with each other at the same point (axis). The rotation center 1802 of the eccentric body 180 (the rotation center 1852 of the eccentric body 185) is located at the center of gravities of the center 1801 of the eccentric body 180 and the center 1851 of the eccentric body 185. Each thickness of the eccentric bodies 180 and 185 is smaller than the size of the center hole 1810 such that the eccentric bodies 180 and 185 can be inserted into the center hole 1810. The bearing 1814 is provided between the center hole 1810 and the eccentric bodies 180 and 185 such that the contact between the center hole 1810 and the eccentric bodies 180 and 185 becomes smooth. The eccentric bodies 180 and 185 contact the bearing 1814 disposed on the center hole 1810 on the sides opposite to the rotation centers 1802 and 1852 as viewed from the centers 1801 and 1851. These contact positions are hereinafter referred to as contact points 1803 and 1853.

Returning to FIG. 10, the connection structure in the cyclo-mechanism in the third embodiment is hereinafter explained. According to the third embodiment, the eccentric bodies 180 and 185 are combined with the rotor 121 as one body. The outside pins 182 are combined with the stator (casing 122) as one body. The inside pins 183 are combined with the load connection portion 133 as one body. In other words, the eccentric bodies 180 and 185, the outside pins 182, and the inside pins 183 function as an input unit, a fixing unit, and an output unit, respectively.

The operation of the cyclo-mechanism under connection is now discussed with reference to FIG. 11. When the rotor 121 (FIG. 10) rotates, the eccentric body 180 rotates accordingly. In this case, the eccentric body 180 rotates around the rotation center 1802. When the eccentric body 180 rotates clockwise as illustrated in FIG. 11, for example, the position of the contact point 1803 rotates clockwise accordingly. As a result, the curved plate 181 receives a force from the eccentric body 180 via the bearing 1814, in which condition the eccentric body 180 moves around anticlockwise along the circumference on which the outside pins 182 are disposed, as revolution on its axis. During this revolution of the curved plate 181 on its axis, the positions of the inside pin holes 1811 move around. The inside pin holes 1811 thus moving around press the inside pins 183, whereby the inside pins 183 move around along the circumference on which the inside pins 183 are disposed. According to this embodiment, one rotation of the eccentric body 180 rotates the curved plate 181 by 1/9 of one rotation of the curved plate 181. For example, when the n protrusions of the epitrochoid parallel curve shape of the curved plate 181 and the (n+1) outside pins 182 are provided, the curved plate 181 rotates by 1/n of one rotation together with one rotation of the eccentric body 180. Therefore, the reduction ratio becomes extremely large. Moreover, the outside pins 182 convert sliding contact into rolling contact. In this case, the mechanical loss considerably decreases, and therefore the gear efficiency extremely improves.

Returning to FIG. 10, the brake in the third embodiment is hereinafter described. According to the third embodiment, the rotor 121 has a hollow cylindrical shape one surface of which is opened similarly to the first and second embodiments. The rotor 121 has the first frictional portion 2121 on the inner surface of the opened end of the cylindrical portion of the rotor 121. The stator includes the braking actuator 2100 and the brake pad 2110 in the vicinity of the roots of the outside pins 182.

FIG. 12 schematically illustrates the brake in the third embodiment. According to the third embodiment, the brake pad 2110 is contained inside the hollow cylindrical rotor 121 similarly to the first and second embodiments. However, in the third embodiment, the first frictional portion 2121 is disposed on the side surface of the rotor 121, and sandwiched between second frictional portions 2110a and 2110b. The second frictional portion 2110a located on the inner circumferential side of the first frictional portion 2121 moves away from the first frictional portion 2121 during non-braking and contacts the first frictional portion 2121 during braking. The second frictional portion 2110b is disposed on the outer circumferential side of the first frictional portion 2121 at a position close to but not contacting the first frictional portion 2121. The braking actuator 2100 is connected with the stator (FIG. 1) via a pin 2108. During braking, the second frictional portion 2110a is pressed against the first frictional portion 2121, whereby braking is applied by the friction generated between the first frictional portion 2121 and the second frictional portion 2110a. In this case, the braking actuator 2100 shifts toward the center of the rotor 121 by a reaction force thus generated, which brings the second frictional portion 2110b into contact with the first frictional portion 2121. According to this embodiment, therefore, braking is applied by the hold of the first frictional portion 2121 between the second frictional portions 2110a and 2110b. Therefore, lowering of the braking force caused by deformation of the rotor 121 does not easily occur, which further raises the braking force.

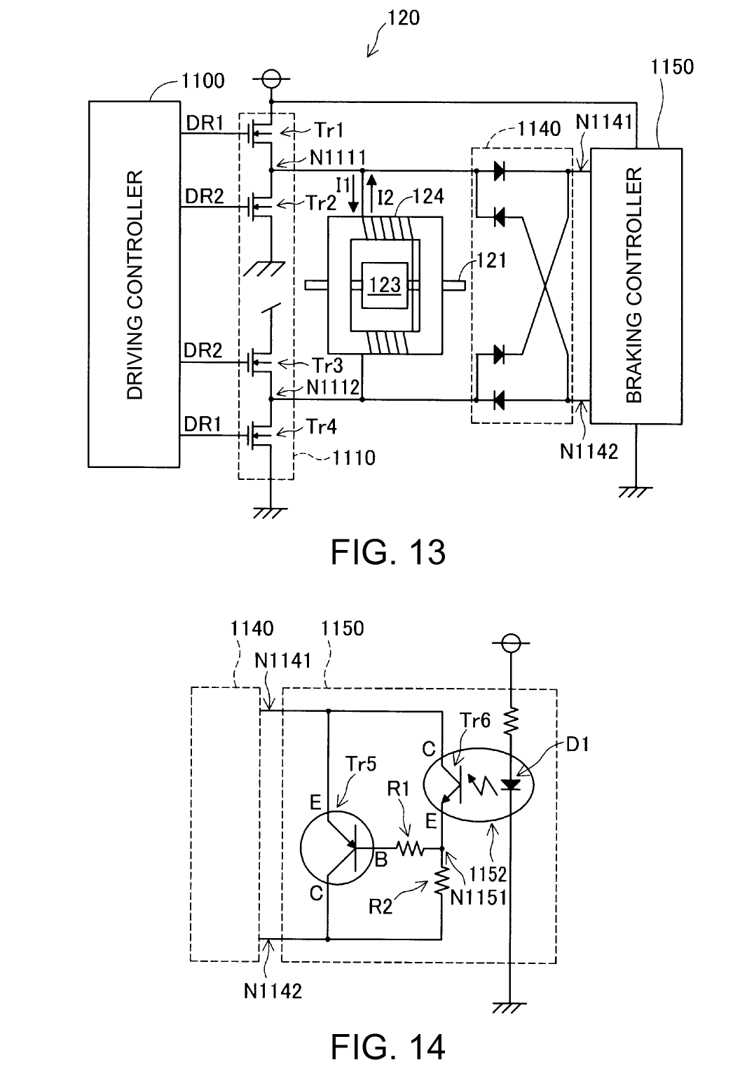

FIG. 13 schematically illustrates the structure of the motor unit according to an example of the respective embodiments of the invention. The motor unit 120 includes a driving controller 1100, an H-type bridge circuit 1110, the electromagnetic coil 124, the permanent magnet 123, the rotor 121, a rectification circuit 1140, and a braking controller 1150. The H-type bridge circuit 1100 has transistors Tr1 and Tr2 connected in series, and transistors Tr3 and Tr4 connected in series. The driving controller 1100 outputs two types of driving signals DR1 and DR2. The driving signal DR1 drives the transistors Tr1 and Tr4, while the driving signal DR2 drives the transistors Tr2 and Tr3. One and the other end of the electromagnetic coil 124 are connected with an intermediate node N1111 between the transistors Tr1 and Tr2, and an intermediate node N1112 between the transistors Tr3 and Tr4, respectively. The permanent magnet 123 is disposed inside the electromagnetic coil 124 and connected with the rotor 121. The input end of the rectification circuit 1140 is connected with both the ends of the electromagnetic coil 124, i.e., the nodes N1111 and N1112. The braking controller 1150 is connected with the output end (nodes N1141 and N1142) of the rectification circuit 1140.

FIG. 14 illustrates the structure of the braking controller 1150. The braking controller 1150 has a transistor Tr5 and an optical isolator 1152. The transistor Tr5 is a PNP-type power transistor whose emitter and collector are connected with the nodes N1141 and N1142, respectively. The optical isolator 1152 has a photo diode D1 and a photo transistor Tr6. The emitter of the photo transistor Tr6 is connected with the base of the transistor Tr5 via a resistor R1, and further connected with the collector of the transistor Tr5 via a resistor R2. The collector of the photo transistor Tr6 is connected with the emitter of the transistor Tr5.

The operation during cutoff of power supply to the motor unit 120 is now explained. When power supply to the motor unit 120 is cut off in the structure shown in FIG. 13, the outputs of the driving signals DR1 and DR2 transmitted from the driving controller 1100 become zero. Similarly, the power and the ground of the H-type bridge circuit 1100 become zero. As a result, the transistors Tr1 through Tr4 are all turned off.

After cutoff of power supply, the rotor 121 still maintains its rotational movement by the inertial force. Thus, the permanent magnet 123 keeps rotating, whereby back induced electromotive force currents I1 and I2 are generated in the electromagnetic coil 124 according to the Fleming's right hand rule. The back induced electromotive force currents I1 and I2 alternately flowing in the electromagnetic coil 124 in the directions I1 and I2 in accordance with the phases of the permanent magnet 123 are rectified by the rectification circuit 1140, and supplied to the braking controller 1150 as current flowing in the same direction.

When power supply is cut off in the structure shown in FIG. 14, the photo diode D1 under the ON condition is turned off and stops light emission. As a result, the photo transistor Tr6 under the ON condition is turned off. On the other hand, current flows from the node N1142 toward the electromagnetic coil 124 via the rectification circuit 1140. In this case, the potential of the emitter (node N1151) of the photo transistor Tr6 drops, whereby a potential difference is produced between the base and the emitter of the transistor Tr5. When this potential difference exceeds a threshold, current flows between the base and the emitter. As a consequence, the transistor Tr5 is turned on, and current flows between the emitter and the collector. In this condition, the electromagnetic coil 124, the rectification circuit 1140, and the transistor Tr5 form a closed circuit, and the motor unit 120 functions as a rheostatic brake. More specifically, the generated back induced electromotive forces are consumed by the transistor Tr5, for example, and generate a rotational resistance in the motor unit 120. This rotational resistance becomes a braking force for the motor unit 120, i.e., a force for braking the rotational movement of the motor unit 120. Generally, the rheostatic brake generates a larger braking force when the resistance is small. It is therefore preferable that the ON-state resistance of the transistor Tr5 is set at a small value.

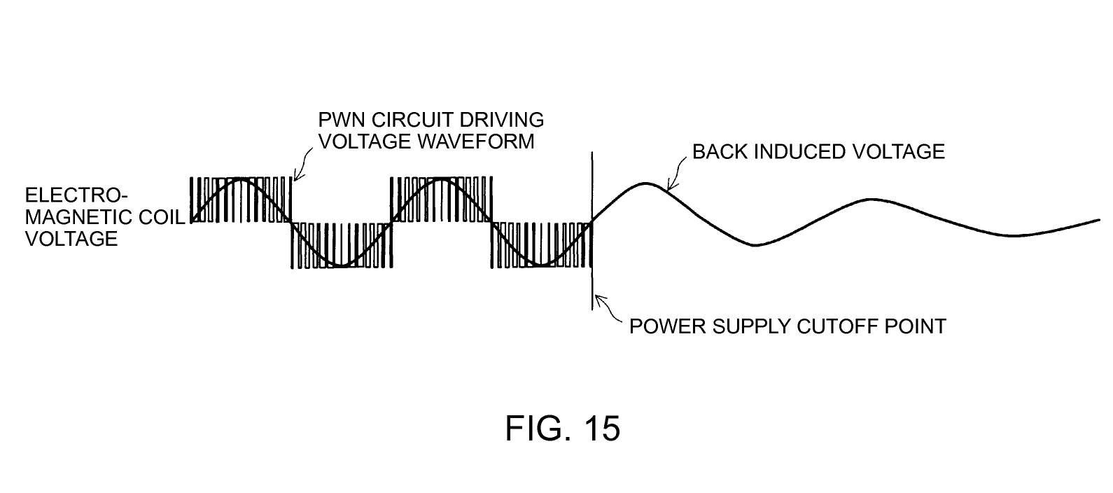

FIG. 15 illustrates the voltages generated in the electromagnetic coil. Until cut off of power supply, a substantially sinusoidal voltage waveform is generated in the electromagnetic coil 124 by the driving from the driving controller 1100. When power supply is cut off, a substantially sinusoidal induced voltage waveform is produced in the electromagnetic coil 124. The value of the induced voltage is dependent on the rotational speed of the rotor 121. When power supply is cut off, the rheostatic brake is applied as explained above. In this case, the rotational speed of the rotor 121 decreases. Accordingly, the induced voltage waveform gradually attenuates. Also, the cycle of the sinusoidal waves increases.

According to this example, the transistor Tr5 of the braking controller 1150 is turned on and forms a closed circuit together with the electromagnetic coil 124 and the rectification circuit 1140 at the time of cutoff of power supply. In this case, the motor unit 120 functions as a rheostatic brake capable of braking the motor unit 120.

According to this example, the rectification circuit 1140 is constituted by a full-wave rectification circuit. In this case, the back induced electromotive force currents flowing in the closed circuit increase, wherefore the braking force rises. The rectification circuit 1140 provided as the full-wave rectification circuit in this example may be constituted by a half-wave rectification circuit or other types of rectification circuit. It is preferable, however, that the full-wave rectification circuit is employed because of its larger braking force at the time of cutoff of power supply.

According to this example, the transistor Tr5 is used as a turn-on switch at the time of cutoff of power supply. The use of the semiconductor switch of the transistor Tr5 eliminates the necessity for providing a mechanical contact, which increases the operation reliability.

According to this example, the optical isolator 1152 is used for the on/off control of the transistor Tr5. Thus, only the simple structure is equipped for the on/off control of the transistor Tr5, which increases the operation reliability.

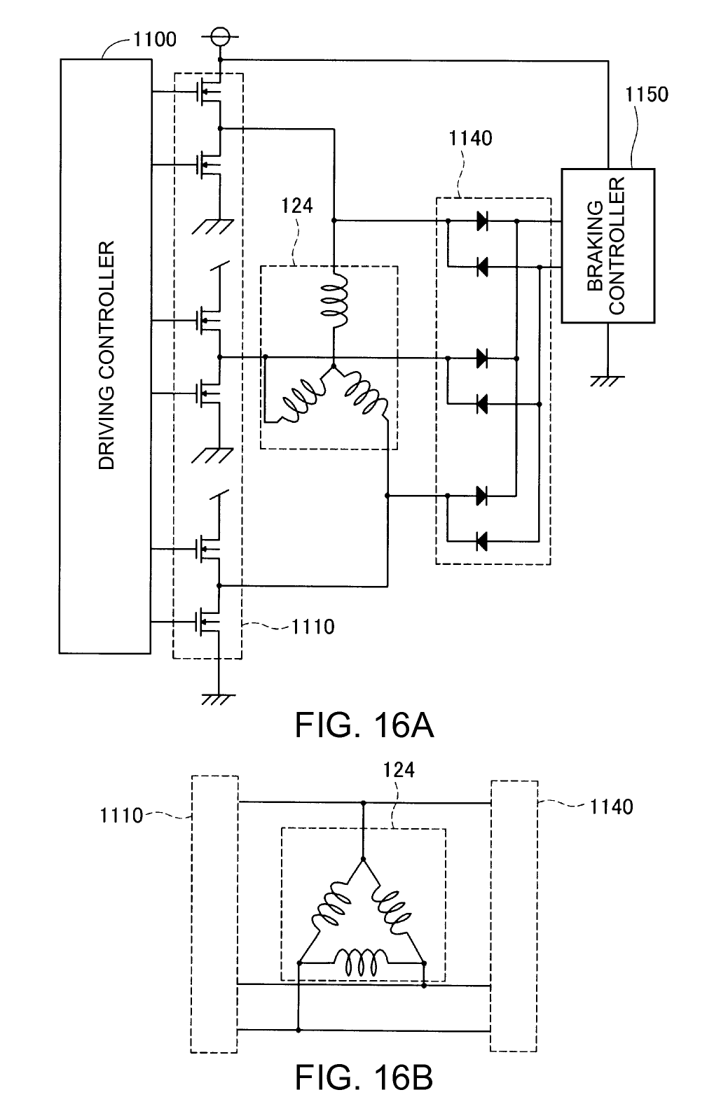

FIGS. 16A and 16B schematically illustrate the structure of the motor unit 120 according to another example. This example is different from the above example in that the motor unit 120 is a three-phase motor. Similarly to the above example, the transistor Tr5 of the braking controller 1150 of the three-phase motor in this example can be turned on and form a closed circuit together with the electromagnetic coil 124 and the rectification circuit 1140 at the time of cutoff of power supply. In this case, the motor unit 120 similarly functions as a rheostatic brake capable of braking the motor unit 120. In the case of the three-phase motor, the electromagnetic coil 124 may be connected by a Y connection (star connection) as illustrated in FIG. 16A, or may be connected by a triangle connection (delta connection) as illustrated in FIG. 16B.

FIG. 17 schematically illustrates the structure of the braking controller in a further example. According to this structure, braking is not immediately applied by the braking pad 2110 at the time of cutoff of power supply, but initially applied by a rheostatic brake produced by the back electromotive force generated in the electromagnetic coil 124, and then physical braking is applied by the brake bad 2110 after an elapse of predetermined time. This structure includes a rotor stopper 1160, an optical isolator 1162, and a delay circuit 1180 in addition to the structure shown in FIG. 14. The rotor stopper 1160 is a braking device capable of physically braking the rotor 121 when no current flows, and includes the first frictional portion 2121, the braking actuator 2100, and the brake pad 2110 shown in FIG. 4. The optical isolator 1162 has a photo diode D2 and a photo transistor Tr7. The photo diode D2 of the optical isolator 1162 is connected with the photo diode D1 of the optical isolator 1152. The photo transistor Tr7 is disposed between the rotor stopper 1160 and the ground. The rotor stopper 1160 includes the braking actuator 2100 shown in FIG. 7. The photo transistor Tr7 is connected with the coil 2102 of the braking actuator 2100 shown in FIG. 7 in series. The delay circuit 1180 has a diode D3, a resistor R3, and a capacitor C1. The cathode of the diode of the delay circuit 1180 is connected with the rotor stopper 1160.

In response to cutoff of power supply, the photo diode D2 under the ON condition is turned off and stops light emission. As a result, the photo transistor Tr7 under the ON condition is turned off. On the other hand, the capacitor C1 remains charged even after cutoff of power supply. Therefore, current flows in the rotor stopper 160 by electric discharges from the capacitor C1 for a predetermined period determined by a time constant (R3·C1). Since current flows in the coil 2102 of the braking actuator 2100 shown in FIG. 7, braking does not start immediately after cutoff of power supply. During this period, a rheostatic brake is applied between the electromagnetic coil 124 and the permanent magnet 123 (FIG. 1, for example). After an elapse of time, the charge in the capacitor C1 decreases, wherefore the amount of current flowing in the coil 2102 of the braking actuator 2100 decreases. As a result, the spring 2104 starts pressing the brake pad 2110 against the first frictional portion 2121. According to this example, therefore, braking by the rotor stopper 1160 starts after an elapse of the predetermined time from cutoff of power supply. In this case, application of braking begins after decrease in the rotation number of the rotor 121, which achieves sizes reduction of the braking actuator 2100 and the brake pad 2110. Moreover, since the rotating mechanism 130 as the speed-reduction gear is provided, the rotation of the rotor 121 prior to initiation of braking scarcely affects load drop. The diode D3 prevents consumption of current discharged from the capacitor C1 by the diode D1.

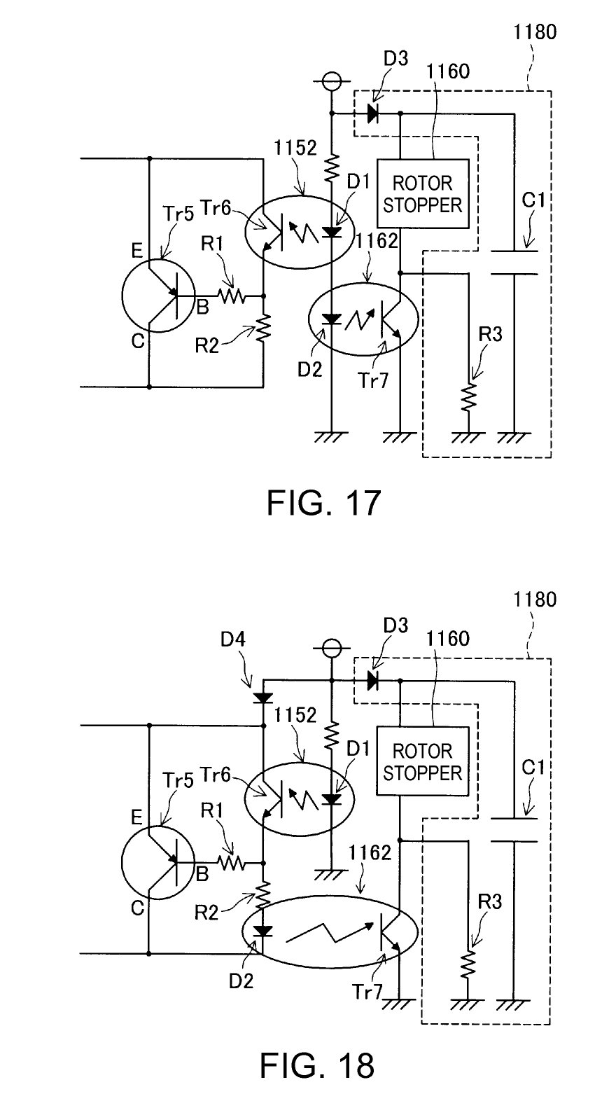

FIG. 18 schematically illustrates the structure of the braking controller according to a still further example. Differently from the braking controller shown in FIG. 17, the photo diode D2 of the optical isolator 1162 in this example is connected with the photo transistor Tr6 of the optical isolator 1152 in series. Moreover, a diode D4 is further provided between the photo transistor Tr6 of the optical isolator 1152 and the power source.

According to this example, current flows in the photo diode D1 during power supply. In this case, the photo transistor Tr6 of the optical isolator 1152 is turned on. Since the diode D4, the photo transistor Tr6, and the photo diode D2 are connected in series with the power source, the photo diode D2 is also turned on. As a result, the photo transistor Tr7 of the optical isolator 1162 is turned on. In this condition, current flows in the coil 2102 of the braking actuator 2100 included in the rotor stopper 1160, wherefore no braking is applied.

On the other hand, during cutoff of power supply, the photo diode D1 is turned off, in which condition the photo transistor Tr6 is also turned off. However, while the number of rotations of the driving power generator 100 is large, high induced voltage is generated and applied between the emitter and the base and between the emitter and the collector of the transistor Tr6. As a result, forward direction current flows from the emitter to the base in the PN direction, wherefore the photo diode D2 remains in the ON condition. Accordingly, the photo transistor Tr7 is kept turned on and allows current flow to the rotor stopper 1160. During cutoff of power supply, the source of current supply to the rotor stopper 1160 is only the capacitor C1. When the charge in the capacitor C1 decreases, current flowing in the coil 2102 of the braking actuator 2100 included in the rotor stopper 1160 decreases accordingly. As a result, the spring 2104 presses the brake pad 2110 against the first frictional portion 2121, thereby initiating application of braking. More specifically, at the time of cutoff of power supply in the structure shown in FIG. 18, induced voltage generated in the electromagnetic coil 124 shown in FIG. 16A by the rotation of the rotor 121 rotating within the motor unit 120 passes through the rectification circuit 1140, whereby regenerative current (short-circuit current) flows under the ON condition of the transistor Try. As a result, the rotor 121 decreases its number of rotations to a condition of stop. When the number of rotations of the rotor 121 becomes a number immediately before stop, the induced voltage generated in the electromagnetic coil 124 decreases to a low voltage. In this condition, the forward direction current flowing in the photo diode D2 comes to the OFF condition and turns off the photo transistor Tr7. Consequently, the rotor stopper 1160 comes into a pre-excitation condition where braking is applied by the braking actuator 2100. Accordingly, no large-scale braking mechanism is required for initiating braking during a period close to stop. While braking is applied by utilizing the characteristics of the forward direction current in the photo diode D2 in this example, such a structure may be employed which advances application timing of braking by raising the operation voltage by the use of a zener diode (constant-voltage diode) provided in series with the photo diode D2.

More specifically, during cutoff of power supply to the motor unit 120 in this example, the photo diode D2 is turned on due to large induced voltage when the number of rotations of the rotor 121 is larger than that number determined in advance. In this case, the photo transistor Tr7 is kept turned on, and the rotor 121 is allowed to rotate without application of braking by the braking actuator 2100. Simultaneously, regenerative current produced by the induced voltage generated in the motor unit 120 applies regenerative braking, wherefore the number of rotations of the rotor 121 decreases. When the number of rotations of the rotor 121 becomes smaller than the predetermined number (such as the number of rotations immediately before stop) by application of the regenerative braking, the photo diode D2 is turned off due to the low induced voltage. As a result, the photo transistor Tr7 is turned off, in which condition the braking actuator 2100 starts application of braking.

It is intended that the respective embodiments described and depicted by means of several specific examples are shown as only examples given for easy and clear understanding of the invention, and do not at all limit the scope of the invention. Accordingly, various modifications, improvements and the like may be made without departing from the scope and spirit of the invention as claimed in the appended claims, and therefore any equivalents of those changes and others are included in the scope of the invention.

The present application claims the priority based on Japanese Patent Application No. 2011-060812 filed on Mar. 18, 2011, the disclosure of which is hereby incorporated by reference in its entirety.

What is claimed is:

1. An electric motor comprising:
a rotor; and
a stator,
wherein
a part of the rotor includes a first frictional portion forming a movement locus, and
the stator includes
a second frictional portion which brakes and stops the rotation of the rotor by a mechanical frictional force produced by contact between the second frictional portion and the first frictional portion, and
a braking actuator which does not allow application of braking by shifting the second frictional portion away from the first frictional portion during power supply to the electric motor, and allows application of braking by pressing the second frictional portion against the first frictional portion during cutoff of power supply to the electric motor.

2. The electric motor according to claim 1, wherein
the rotor has a hollow cylindrical shape one bottom of which is opened, and includes the first frictional portion disposed on the inner surface of the hollow cylindrical shape of the rotor; and
the second frictional portion and the braking actuator are disposed inside or at the opened end of the hollow cylindrical shape of the rotor.

3. The electric motor according to claim 2, wherein
the first frictional portion is disposed inside the cylindrical side surface of the hollow cylindrical shape; and
the braking actuator presses the second frictional portion against the first frictional portion in a radial direction.

4. The electric motor according to claim 2, wherein the first frictional portion is disposed on the bottom of the hollow cylindrical shape on the side not opened.

5. The electric motor according to claim 3, wherein
the first frictional portion has a convex or concave shape with respect to the second frictional portion; and
the second frictional portion has a concave or convex shape with respect to the first frictional portion as the opposite shape of the first frictional portion.

6. The electric motor according to claim 1, further comprising
a braking controller which controls the operation of the braking actuator,
wherein
the braking controller has a delay circuit which allows the braking actuator to apply braking after an elapse of a predetermined time from cutoff of power supply to the electric motor,
during power supply to the electric motor, the braking controller rotates the rotor without allowing the braking actuator to apply braking, and
during cutoff of power supply to the electric motor, the braking controller draws regenerative current produced by induced voltage generated by the electric motor to allow application of braking of the rotor by utilizing the regenerative current as regenerative braking, in which case the braking controller allows the braking actuator to apply braking after the elapse of the predetermined time.

7. An electric motor comprising:
a rotor;
a stator;
a braking unit which brakes the rotation of the rotor;
a braking actuator which operates the braking unit; and
a braking controller which controls the operation of the braking actuator,
wherein
the braking controller has a delay circuit which allows the braking actuator to apply braking after an elapse of a predetermined time from cutoff of power supply to the electric motor,
during power supply to the electric motor, the braking controller rotates the rotor without allowing the braking actuator to apply braking, and
during cutoff of power supply to the electric motor, the braking controller draws regenerative current produced by induced voltage generated by the electric motor to allow application of braking by utilizing the regenerative current as regenerative braking, in which case the braking controller allows the braking actuator to apply braking after the elapse of the predetermined time.

8. An electric motor comprising:
a rotor;
a stator;
a braking unit which brakes the rotation of the rotor;
a braking actuator which operates the braking unit; and
a braking controller which controls the operation of the braking actuator,
wherein
the braking controller has a delay circuit which allows the braking actuator to apply braking after an elapse of a predetermined time from cutoff of power supply to the electric motor,
during power supply to the electric motor, the braking controller rotates the rotor without allowing the braking actuator to apply braking, and
during cutoff of power supply to the electric motor, the braking controller rotates the rotor without allowing the braking actuator to apply braking and draws regenerative current produced by induced voltage generated by the electric motor to allow application of braking by utilizing the regenerative current as regenerative braking when detecting a large number of rotations of the electric motor based on the induced voltage corresponding to the large number of rotations of the electric motor, and allows the braking actuator to apply braking when detecting a small number of rotations of the electric motor based on the induced voltage corresponding to the small number of rotations of the electric motor.

9. A robot comprising the electric motor according to claim 1.

10. A robot comprising the electric motor according to claim 2.

11. A robot comprising the electric motor according to claim 3.

12. A robot comprising the electric motor according to claim 4.

13. A robot comprising the electric motor according to claim 5.

14. A robot comprising the electric motor according to claim 6.

15. A robot comprising the electric motor according to claim 7.

16. A robot comprising the electric motor according to claim 8.
